(19) United States
(12) Patent Application Publication
(10) Pub. No.: US 2014/0365041 A1
(43) Pub. Date: Dec. 11, 2014

(54) METHOD FOR MANAGING A VERTICAL FLIGHT PLAN

(71) Applicant: THALES, Neuilly-sur-Seine (FR)

(72) Inventors: Guy Deker, Cugnaux (FR); Samuel Orzan, Bordeaux (FR); Bertrand Caudron De Coqueraumont, Tournefeuille (FR); Philippe Chaix, Tournefeuille (FR)

(21) Appl. No.: 14/362,023

(22) PCT Filed: Nov. 30, 2012
(86) PCT No.: PCT/EP2012/074107

§ 371 Date: May 30, 2014

(30) Foreign Application Priority Data
Dec. 2, 2011 (FR) 1103684

(51) Int. Cl. G08G 5/00; B64C 19/00

(52) U.S. Cl. CPC G08G 5/0039; G08G 5/003; B64C 19/00
USPC 701/4

(57) ABSTRACT

A method for managing a vertical flight plan comprises: a first step of breaking down an initial flight plan into a succession of contiguous segments, each segment comprising a change of altitude and/or of speed; a second step of calculating a lateral flight path of the flight plan based on the contiguous segments; a third step of calculating a vertical profile and a speed profile based on the calculated lateral flight path; a fourth step is a step of determining an active segment during the flight of the aircraft, by longitudinal distance sequencing of the contiguous segments. The method is notably suitable for the integration of tactical flight segments into a flight plan.

The present invention relates to a method for managing a vertical flight plan and, notably, the integration of tactical flight segments into a flight plan. The invention can notably be applied to a flight management system, known as an “FMS”, the acronym for “Flight Management System”.

Civil aircraft may have to fly according to altitude instructions, speed instructions, or other constraints in order to be compatible with specific procedures in force in certain controlled airspaces, or in the context of civil operations such as special missions carried out by government aircraft for example.

One of the technical problems encountered during the taking into account of these specific procedures arises from the necessity of having to manage, within the flight plan, sequences of procedures or flight segments of several types notably with specific altitude and speed profiles, on the basis of a generic data structure notably comprising sequences of segments having constant parameters integrating their transition. By nature, each type of procedure is specific and can require anticipated or non-anticipated changes of altitude, and/or anticipated or non-anticipated changes of speed associated with altitude criteria or distance criteria.

Usually, the altitude changes are carried out starting from a fixed point until intercepting an altitude of a next segment without knowing a priori the position of the interception in the next segment. This taking into account of altitude changes is not compatible, for example, with a flight instruction demanding that the change of altitude should be completed at a given fixed point.

According to the prior art, some modern aircraft comprise a flight management system capable of taking account of several “altitude steps” or altitude changes planned to start from fixed points in the flight plan, solely during the cruise phase.

Some flight management systems also have a capability of planning tactical procedures, but this is generally independent of the civil flight plan management section and is carried out without the possibility of linking the tactical and civil procedures together and notably without the possibility of integrating them within a sequence of flight phases allowing a continuity of the altitude, speed, time and fuel predictions along these linked procedures.

A purpose of the invention is notably to overcome the aforesaid disadvantages. For this purpose, the invention relates to a method for managing a vertical flight plan comprising at least:
a first step of breaking down an initial flight plan into a succession of contiguous segments, each segment comprising a change of altitude and/or of speed;
a second step of calculating a lateral flight path of the flight plan based on the contiguous segments;
a third step of calculating a vertical profile and a speed profile based on the calculated lateral flight path;
a fourth step is a step of determining an active segment during the flight of the aircraft, by longitudinal distance sequencing of the contiguous segments.

Advantageously, each segment can comprise:
at least one point of the initial flight plan;
a phase of transition between two consecutive segments providing continuity of the flight profiles with regard to altitude and speed between two consecutive segments.

The method according to the invention can advantageously comprise a fifth step of generating guidance instructions on the basis of the active segment.

The guidance instructions can advantageously be displayed through a dedicated man-machine interface.

The controls of the aircraft can advantageously be slaved to the guidance instructions.

The method according to the invention can furthermore comprise a step of modification of the contiguous segments, the contiguous segments being automatically updated in order to integrate the modification, the modification step being followed by third and fourth steps of calculating a lateral flight path, of calculating a vertical profile and a speed profile.

Each flight plan can advantageously be constituted by a sequence of generic segments.

Each flight plan can be stored in a memory of the flight management system in the form of a sequence of generic segments.

The list of points of each flight plan is advantageously able to be reduced for display with the list of the generic segments composed of these points.

The present invention furthermore relates to a device for managing a vertical flight plan of an aircraft comprising a flight management system and man-machine interfaces. The flight management system:
breaks down an initial flight plan into a succession of contiguous segments, each segment comprising a change of altitude and/or of speed;
calculates a lateral flight path of the flight plan on the basis of the contiguous segments;
calculates a vertical profile and a speed profile on the basis of the calculated lateral flight path;
determines an active segment, during the flight of the aircraft, by a longitudinal distance sequencing of the contiguous segments.

The flight management system can break down the initial flight plan into segments comprising:
at least one point of the initial flight plan;
a phase of transition between two consecutive segments providing continuity of the flight profiles with regard to altitude and speed between two consecutive segments.

The flight management system can generate guidance instructions on the basis of the active segment.

The man-machine interfaces notably display the guidance instructions.

The flight management system transmits the guidance instructions to an automatic pilot of the aircraft.

The device can modify continuous segments, the contiguous segments being automatically updated in order to integrate the modification, the modification of contiguous segments being followed by calculation of a lateral flight path, calculation of a vertical profile and of a speed profile.

The present invention also relates to a device for managing a vertical flight plan of an aircraft comprising a flight management system and man-machine interfaces, said flight management system comprising:
a function FPLN breaking down an initial flight plan into a succession of contiguous segments, each segment comprising a change of altitude and/or of speed, at least one point of the of the initial flight plan, a phase of transition between two consecutive segments providing continuity of the flight profiles with regard to altitude and to speed between two consecutive segments, said FPLN function modifying the contiguous segments when there is a modification request coming from a man-machine interface;
a function TRAJ calculating a lateral flight path of the flight plan on the basis of the contiguous segments;
a prediction function calculating a vertical profile and a speed profile on the basis of the calculated lateral flight path;
a guidance function carrying out a longitudinal distance sequencing of the contiguous segments, said distance sequencing being transmitted to the function FPLN, the function FPLN determining an active segment, during the flight of the aircraft.

The guidance function can generate guidance instructions on the basis of the active segment, for sending to an automatic pilot of the aircraft.

The man-machine interfaces can:
notably display, for each of the active, temporary or secondary flight plans:
   the contiguous segments;
   the active segment;
   the principal parameters of the segment: a reference point or a point of departure, an altitude to be reached either exactly at the reference point, or by climbing or descending starting from the reference point, a speed or a flying parameter of the aircraft, a type of segment.
   the guidance instructions;
be adapted for entering modifications of the contiguous segments.

The main advantages of the invention are notably the bringing together and integration, in a generic and simple manner for the crew, of a succession of tactical and civil procedures with their operational criteria and their respective constraints.

Other features and advantages of the invention will become apparent with the help of the following description, given by way of illustration and in a non-limiting manner and with reference to the appended drawings in which:

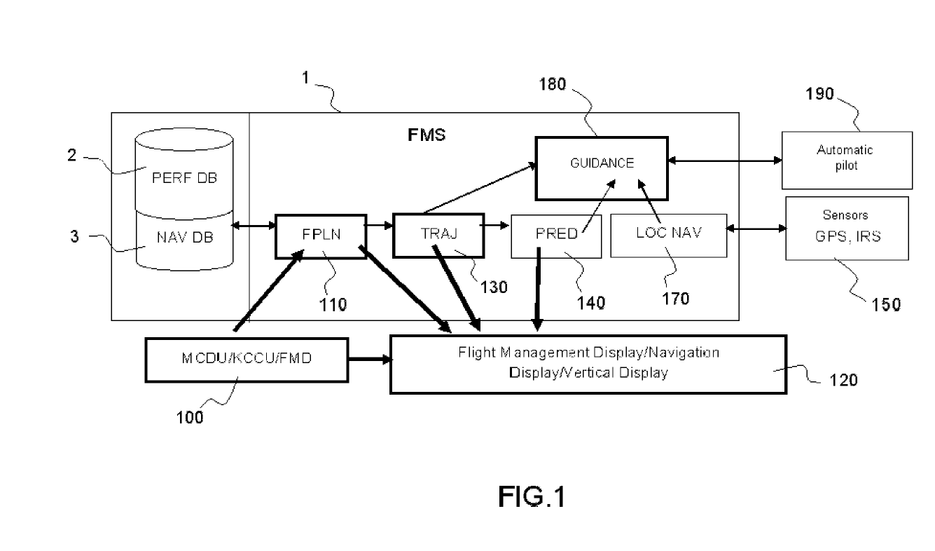

FIG. 1 shows a functional diagram of the different capabilities of an FMS according to the prior art;

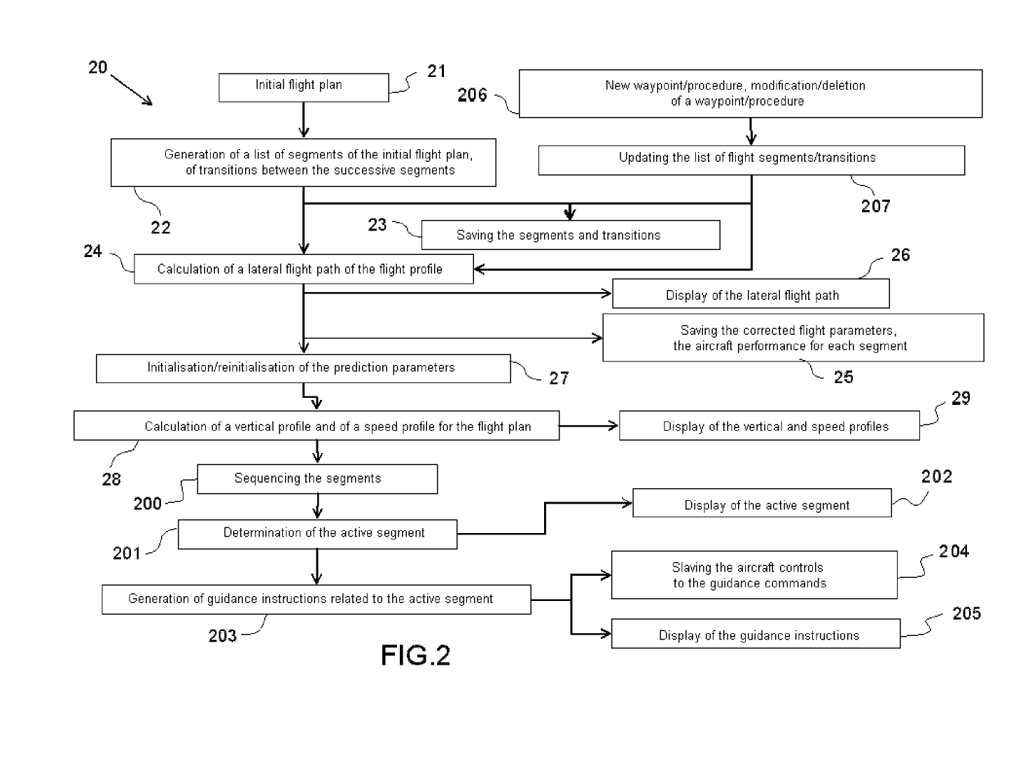

FIG. 2 shows possible steps of the method for managing a flight plan according to the invention;

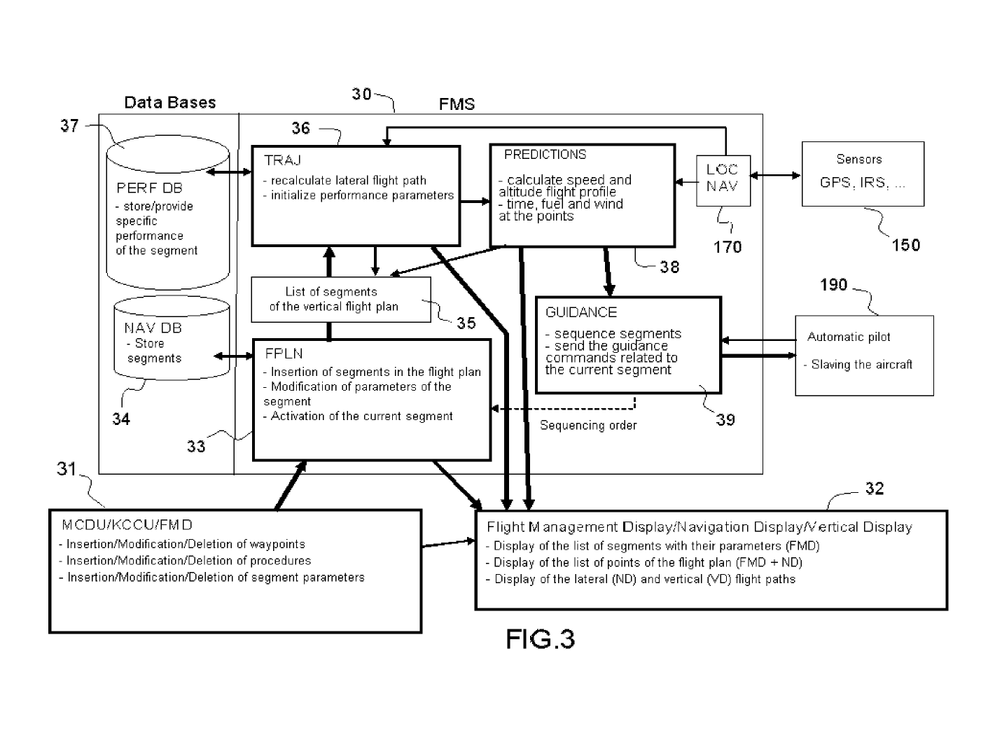

FIG. 3 shows an example of implementation of the method 20 according to the invention;

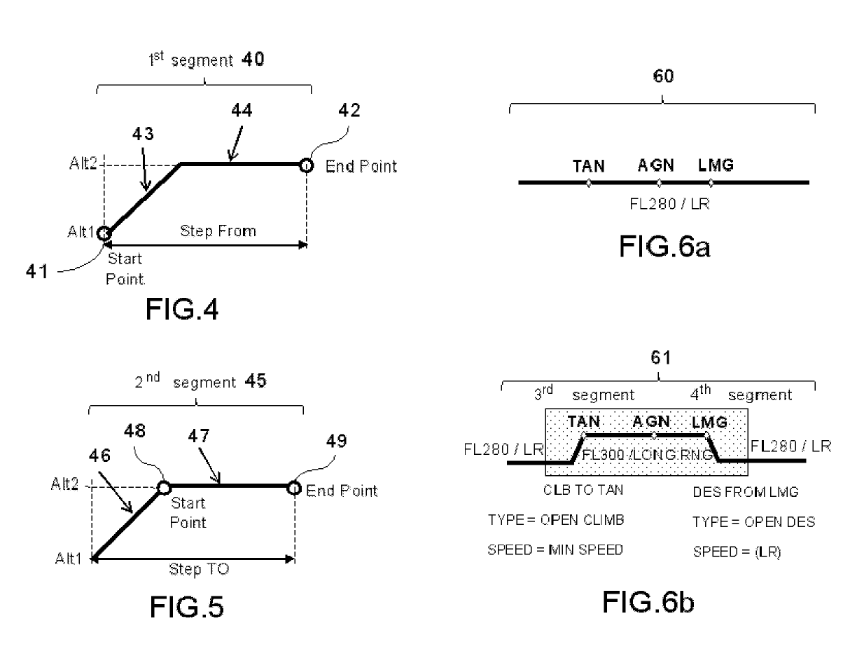

FIG. 4 shows a diagram of a segment of the “Step From” type according to the invention;

FIG. 5 shows a diagram of a segment of the “Step To” type according to the invention;

FIG. 6a shows a diagram of an initial segment of a flight plan according to the prior art;

FIG. 6b shows a diagram of a possible modification according to the invention of the initial segment of a flight plan according to the prior art;

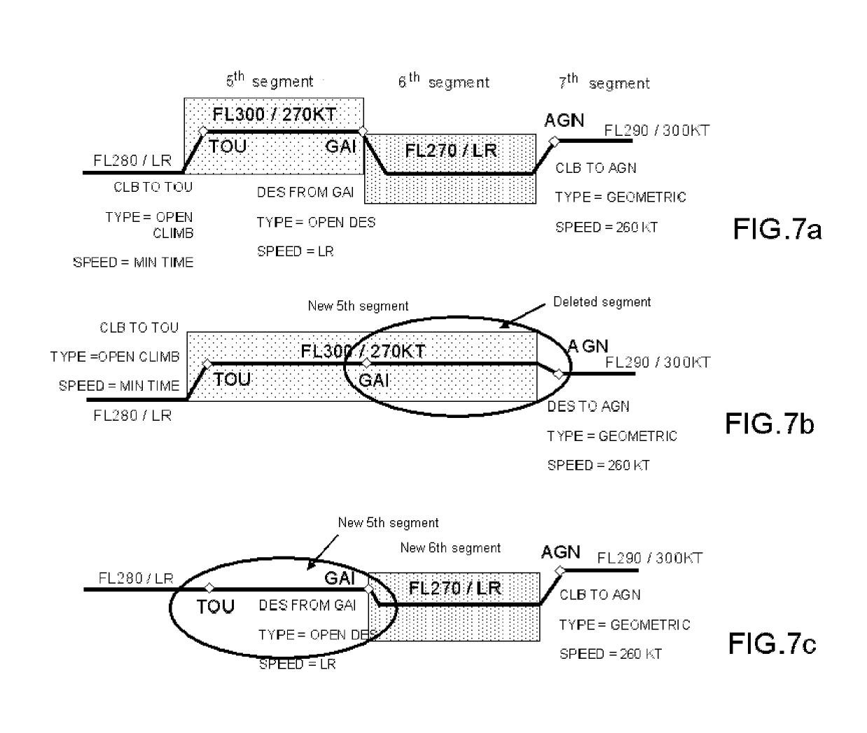

FIG. 7a shows an example of a first set of segments according to the invention;

FIG. 7b shows the first set of segments after deletion of a first segment;

FIG. 7c shows the first set of segments after deletion of a second segment;

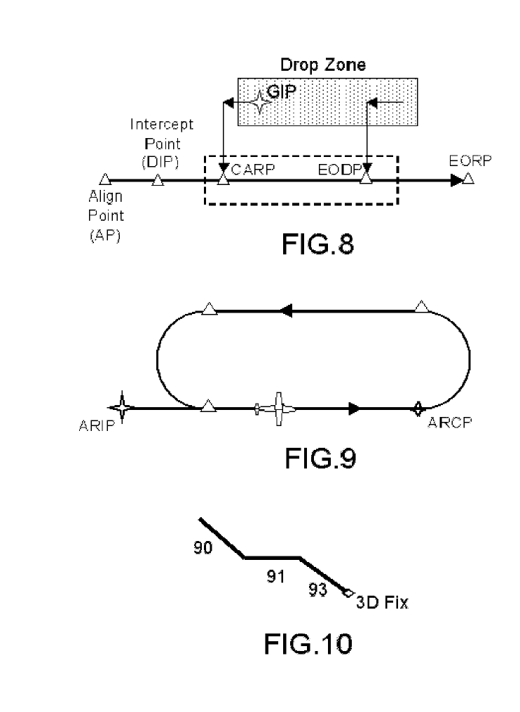

FIG. 8 shows an example of a segment according to the invention describing a drop procedure;

FIG. 9 shows an example of a segment according to the invention describing a refueling procedure;

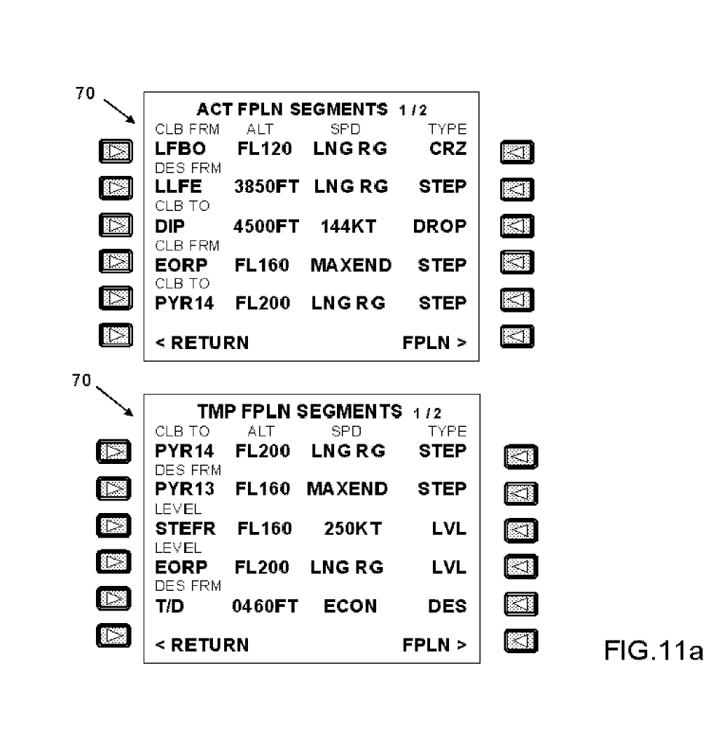

FIG. 10 shows an example of a segment according to the invention describing a fast descent procedure.

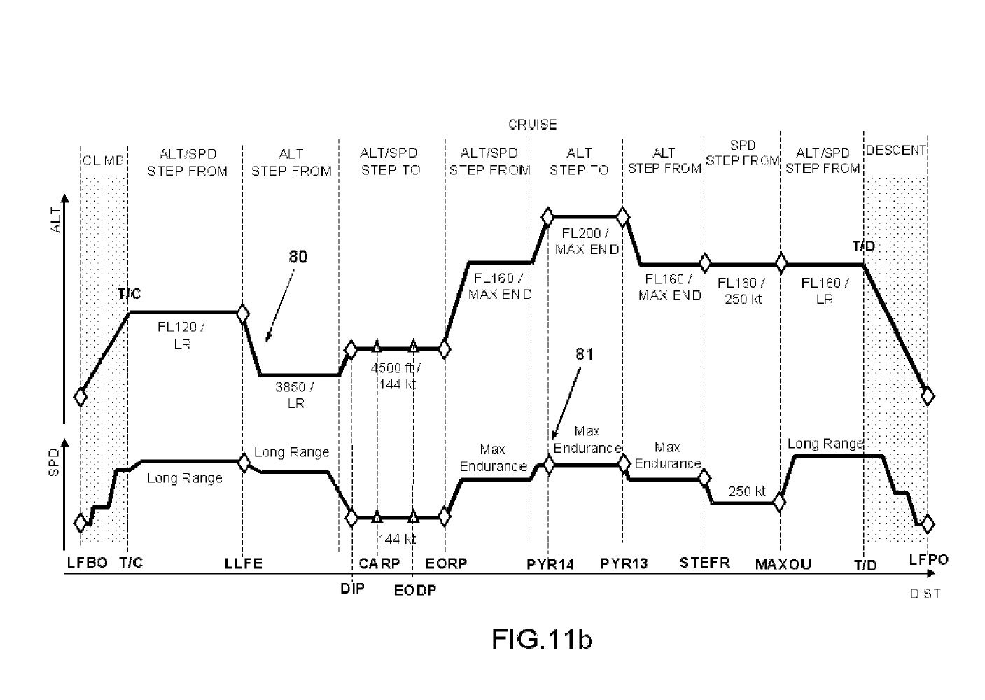

FIG. 11a shows two examples of a page displaying segments according to the invention;

FIG. 11b shows a first example of a sequence of segments according to the invention.

The acronyms used in the present application are expressed in full and explained in the following table:

| Acronym | Full Expression | Meaning |
|---|---|---|
| AIRMASS | Air Mass | Air mass |
| ALT | Altitude | Altitude |
| AP | Align Point | Align Point |
| ARCP | Air Refueling Control Point | In-flight refueling |
| | | control point |
| ARIP | Air Refueling Initial Point | Initial in-flight |
| | | refueling point |
| CARP | Computed Air Release Point | Computed Air |
| | | Release Point |
| CAS | Calibrated Air Speed | Speed calibrated in knots |
| CLB | Climb | Climb |
| CLB TO | Climb to | Climb to |
| CRZ | Cruise | Cruise |
| DB | Data Base | Data Base |
| DES | Descent | Descent |
| DIP | Drop Intercept Point | Drop Intercept Point |
| DIST | Distance | Distance |
| Drop | | Drop |
| Drop Zone | | Drop Zone |
| EODP | End Of Drop Point | End Of Drop Point |
| EORP | End Of Run Point | Exit point |
| END POINT | | End point of segment |
| FL | Flight Level | Flight level |
| Final | | Altitude of interception |
| Capture | | of the last landing |
| Altitude | segment | |
| FMD | Flight Management Display | Flight Management |
| | | Display |
| FMS | Flight Management System | Flight management |
| | | system |
| FPA | Flight Path Angle | Flight Path Angle |
| FPLN | Flight Plan | Flight plan |
| FT | Feet | Feet |
| GIP | Ground Impact Point | Ground Impact Point |
| GPS | Global Positioning system | Global Positioning |
| | | system |
| IHM | Interface Homme Machine | |
| IRS | Inertial Reference System | Inertial Reference |
| | | System |
| KCCU | Keyboard Cursor Control Unit | Keyboard Cursor Control |
| | | Unit |
| Kt | Knot | Knot |
| LEG | | Segment |
| LEVEL | | Flight level |
| LOCNAV | Navigational Localization | Navigational |
| | | Localization |
| LONG | | Long range |
| RANGE | | |
| LR | Long Range | Speed maximizing the |
| | | flight range |
| MACH | | Unit of speed expressed |
| | | as a Mach number |
| MAX END | Max Endurance | Speed maximizing the |
| | | flight time or long |
| | | endurance |
| MCDU | Multifunction Control Display | Multifunction display |
| | Unit | unit |
| NAV | Navigation | Navigation |
| ND | Navigation Display | Navigation screen |
| OPEN | | Climb without altitude |
| CLIMB | | constraint |
| PERF | Performance | Performance |
| PRED | Prediction | Prediction |
| QNH | | Standard atmospheric |
| | | pressure at sea level |
| RNG | Range | Range |
| SAR | Search And Rescue | Search And Rescue |
| SPD | Speed | Speed |
| START | | Start point of the |
| POINT | | segment |
| STEEP | | Fast descent |
| DESCENT | | |
| STEP | | Step |
| STEP FROM | | Step from |
| STEP TO | | Step to |
| TRAJ | Trajectory | Flight path |
| VD | Vertical Display | Display of a vertical |
| | | flight profile |
| Vertical | | Vertical speed |
| Speed | | |
| VHF | Very High Frequency | Very High Frequency |
| Waypoint | | Waypoint |

FIG. 1 shows a functional diagram of different capabilities of a first FMS 1 of an aircraft according to the prior art. The term “FMS” is an acronym for the expression “Flight Monitoring System”, signifying “Flight Management System”. A flight management system can be used by at least one computer installed on board the aircraft. The first FMS 1 notably determines the geometry of a flight plan profile followed by the aircraft. The flight plan profile is computed in four dimensions: three spatial dimensions and a time/speed profile dimension. The first FMS 1 also transmits to a pilot, via a first pilot interface 120, or to an automatic pilot 190, guidance instructions calculated by the first FMS 1 in order to follow the flight profile.

A flight management system can comprise one or more data bases such as the first data base PERF DB 2 and the second data base NAV DB 3. The first and second data bases PERF DB 2, NAV DB 3 respectively comprise performance data of the aircraft and air navigation data, such as routes and beacons.

The management of a flight plan according to the prior art calls upon means of flight plan creation/modification by the crew of the aircraft through one or more man-machine interfaces such as:
a first MCDU, an acronym for Multifunction Control Display Unit;
a first KCCU, an acronym for Keyboard Cursor Control Unit signifying a unit for controlling a cursor and a keyboard;
a first FMD, an acronym for Flight Management Display;
a first interactive ND, an acronym for Navigation Display.

A first capability of the first FMS 1 can be a function for managing a flight plan 110, usually called an FPLN. The term FPLN is an acronym for the expression “Flight Plan”. The first FPLN capability 110 notably makes it possible to manage different geographical elements forming a skeleton of a route to be followed by the aircraft comprising: a departure airport, waypoints, air routes to follow and an arrival airport. The first FPLN capability 110 also makes it possible to manage different procedures forming part of a flight plan such as: a departure procedure, an arrival procedure, one or more holding procedures. The first FPLN capability 110 notably allows the creation, modification and deletion of a primary or secondary flight plan.

The flight plan and its various items of information can be displayed for consultation by the crew using display devices 120, also called man-machine interfaces, present in the cockpit of the aircraft such as a first FMD 120, a first ND 120, a first VD 120. The term VD is an acronym for the expression “Vertical Display”. The first VD 120 notably displays a vertical flight profile.

The first FPLN capability 110 makes use of data stored in the first and second data bases PERF DB 2, NAV DB 3 in order to construct a flight plan. For example, the first data base PERF DB 2 can comprise aerodynamic parameters of the aircraft and characteristics of the engines of the aircraft. The second data base NAV DB 3 can for example comprise the following items: geographical points, beacons, air routes, departure procedures, arrival procedures and altitude, speed or slope constraints.

A second capability 130 of the FMS, called TRAJ 130 in FIG. 1, makes it possible to calculate a lateral flight path for the flight plan defined by the first FPLN capability 110. The second TRAJ capability 130 notably constructs a continuous flight path from points of an initial flight plan whilst complying with the aircraft performance data provided by the first data base PERF DB 2. The initial flight plan can be an active, temporary or secondary flight plan. The continuous flight path can be presented to the pilot by means of one of the man-machine interfaces 120.

A third capability of the FMS 1 can be a first flight path prediction function PRED 140. The first prediction function PRED 140 notably constructs an optimized vertical profile on the basis of the lateral flight path of the flight plan of the aircraft, provided by the TRAJ function 130. For this purpose, the prediction function PRED 140 uses the data of the first data base PERF DB 2. The vertical profile can be presented to the pilot by means for example of a first VD 120.

A fourth capability of the FMS 1 can be a first localization function 3, called LOCNAV 170 in FIG. 1. The first LOCNAV function 170 notably carries out an optimized geographical localization, in real time, of the aircraft as a function of the geographical location means installed on board the aircraft. For example following means can be used by the LOCNAV function 170: a GPS system 150, VHF radio beacons, inertial reference systems IRS 150, altitude and speed sensors 150.

A fifth capability of the FMS 1 can be a first guidance function 180. The first guidance function 180 notably supplies the automatic pilot 190 or one of the man-machine interfaces 120, with flight controls making it possible to guide the aircraft in lateral and vertical geographical planes (altitude and speed) so that aircraft follows the flight path provided in the initial flight plan. The first guidance function 180 calculates for this purpose flight commands whilst notably optimizing the speed of the aircraft for example for the purpose of minimizing the fuel consumption of the aircraft. The flight controls are notably speed, heading, altitude, roll and pitch instructions capable of being taken into account directly by the aircraft controls.

FIG. 2 shows different possible steps of the method for managing a flight plan 20 according to the invention. The method according to the invention can be applied to the various existing flight plans, such as an active flight plan, a temporary flight plan or a secondary flight plan.

One of the principles of the method 20 according to the invention is notably to break down an initial flight plan 21 into a succession of contiguous generic segments. Thus, the flight plan is broken down into as many segments as the number of speed and/or altitude changes it comprises. The segments are defined according to parameters necessary for ensuring transitions between stable parts of the flight plan. The transitions are defined by phases during which the parameters of the flight plan of the aircraft vary. The stable parts are defined by phases during which the parameters of the flight plan remain constant. Advantageously, the breaking down of the initial flight plan into generic segments can be based on a format of segments that is sufficiently open to be suitable for the description of existing or future civil or tactical procedures. The generic segments can be anchored to points of the initial flight plan 21. Each generic segment is associated with parameters necessary for the description of the speed and altitude instructions, of vertical flight path characteristics and parameters necessary for the calculation of speed and/or altitude transitions between two consecutive generic segments.

The initial flight plan is thus broken down into as many generic segments as it contains vertical segments with distinct altitude, speed and aircraft flying parameters. Thus, a generic segment advantageously makes it possible to specify an altitude and speed profile by individualizing each segment for example according to its type: level flight, climb transition, descent transition, specific speed, for example, from or to a reference point of the segment, with changes of speed, altitude and distance. Advantageously, the generic segments thus defined make it possible to take account of different types of changes of flight level and of speed, including changes of flight level or of speed resulting from tactical missions.

The method according to the invention can notably use the following items of data together or separately for manipulating the generic segments:
an entry point and an exit point of a vertical flight segment, used for linking each vertical flight segment to the preceding one and to the following one in the initial flight plan;
a transition between two successive vertical flight segments, in order to establish continuity of altitude and speed between the two consecutive segments;
a deceleration or acceleration associated with a segment, making it possible to anticipate at a distance a speed instruction applied for example to an entry point of a following segment of the flight profile;
a start of transition point of the segment, which can be a point computed by the second FMS 30, or entered by the pilot, said transition point being able or not able to anticipate the entry point of the segment.

In a first example of implementation of the method according to the invention, a vertical flight plan can be divided into vertical flight segments. Each segment has a type corresponding to the type de the procedure associated with it:
a change of level procedure, during a phase of climbing towards a cruise altitude;
a change of flight level procedure starting from a point in a cruise phase, called ALT STEP;
a change of speed procedure, giving an imposed speed segment;
a drop procedure;
a flight refueling procedure;
an SAR (Search and Rescue) procedure;
a fast descent procedure, referred to as STEEP DESCENT;
an intermediate landing procedure;
a change of flight level during a descent and/or approach phase procedure.

The whole of the initial flight plan can thus be summarized as a series of vertical flight plan segments describing the determining steps or phases of the flight or of the missions.

Each of the vertical flight segments can be described with generic parameters such as:
a fixed entry point;
a fixed exit point;
an identifier of the procedure associated with the segment;
a type of segment;
Waypoints with their associated altitude, speed or time constraints;
a part descriptive of the parameters of transition between consecutive segments, notably using the following parameters:
   a speed of transition in Mach or in CAS, or a speed optimization criterion, for example of the Long Range type, signifying a large radius of action;
   a guidance mode used for the transition such as: Open Climb, Vertical Speed, FPA;
   a type of transition:
      a transition starting at the point of entry, called Step From for example;
      a transition ending at the point of entry, called Step To for example;
      a transition without change of flight level, called Level for example;
   a distance of anticipation for a transition of the Step To type;
   a slope or a vertical climb or descent speed;
   a type of engine thrust, a state of the engines;
   an aircraft configuration, for example configuration of the slats, of the flaps;
a part descriptive of the constant parameters, for example:
   a speed in Mach or CAS, or a speed optimization criterion, for example Long Range, referenced LR;
   an altitude in FL or in feet;
   a type of engine thrust, a state of the engines;
   an aircraft configuration, for example configuration of the slats, of the flaps;
   a QNH, a temperature, a wind.

The breaking down of the initial flight plan into generic segments can be carried out during a first step 22 of the method 20 according to the invention. The first step 22 can therefore be a step of generation of a list of segments on the basis of the initial flight plan 21. The expression “list of segments” is used in a general sense here, signifying a set of segments. The set of segments can be represented and/or saved in the form of a list for example.

A second step of the method according to the invention can be a step 23 of saving the segments generated during the first step 22 in a data base.

A third step of the method according to the invention is a step of computing 24 a lateral flight path of a flight profile, said flight profile being computed as a function of the breakdown into segments of the initial flight plan 21.

A fourth step of the method according to the invention can be a step of display 26 of the lateral flight path computed during the third step 24.

A fifth step of the method according to the invention can be a step of saving 25 the flight parameters or performance hypothesis for each segment, and between each segment, in a memory of the second FMS 30.

A sixth step of the method according to the invention can be a step of initialization 27 of prediction parameters on the basis of the flight parameters, instructions regarding the speed to maintain (dependant on the flight mode used), thrust, altitude, vertical speed, slope as well as altitude, speed and time constraints of each segment. The prediction parameters are notably used by the prediction function of the flight management system.

A seventh step can be a step of calculating 28 a vertical profile and a speed profile for the flight plan taking account of the lateral flight path, calculated during the third step 24 of the method according to the invention.

An eighth step of the method 20 according to the invention can be a step of display 29 of the vertical and speed profiles calculated during the seventh step 28.

A ninth step of the method 20 according to the invention is a step of longitudinal distance sequencing 200 of the segments.

A tenth step of the method 20 according to the invention is a step of determination 201 of an active segment from among the list of segments during the flight of the aircraft as a function of the longitudinal distance sequencing 200 of the segments and of the progress of the aircraft on its flight plan. The active segment makes it possible to determine which instructions are applicable for slaving the aircraft to its flight profile. The active segment also makes it possible to establish a link between calculated/predicted parts and static parts of the flight plan.

An eleventh step of the method according to the invention can be a step of display 202 of the active segment determined during the tenth step 201.

A twelfth step of the method according to the invention is a step of generation of guidance instructions 203 for the aircraft, said guidance instructions being linked to the active segment determined during the tenth step 201.

A thirteenth step of the method according to the invention can be a step of display 205 of the guidance instructions intended for the crew for example when the aircraft is not on automatic pilot.

A fourteenth step of the method according to the invention can be a step of slaving 204 of the controls of the aircraft to the guidance instructions or commands, related to the active segment.

A fifteenth step of the method according to the invention can be a step 206 of creation of a new waypoint, a new procedure, of modification, of deletion of a waypoint, of a procedure, associated with the initial flight plan 21. The fifteenth step of the method according to the invention can also be an insertion, modification or direct deletion of a segment of the segment list using a dedicated man-machine interface.

A sixteenth step of the method according to the invention can be a step of updating the list of segments 207 in order to take account of the modification of the flight plan carried out during the fifteenth step 206.

After the sixteenth step 207, the method according to the invention restarts from the second step 23 of saving segments and transitions, then there is again a calculation 24 of the lateral flight path of the flight profile, as well as a reinitialization of the prediction parameters 27, then followed by the other steps of the method according to the invention such as described above.

Thus a traditional flight plan can be constituted no longer by a climb, a cruise, a descent and an approach, but by a succession of segments, the climb and the descent being able to be represented advantageously by transitions between two consecutive segments.

FIG. 3 shows an example of use of the method 20 according to the invention by a second FMS 30 and man-machine interfaces 100, 120 according to the invention.

A creation or a modification of a vertical flight segment can notably be carried out in two ways:
explicitly through an appropriate man-machine interface: by a revision of a point of the flight plan, for example by means of a list enumerating the vertical flight segments of the flight plan, or by means of a dedicated geographical interface;
implicitly by the second FMS 30 for example after an insertion or activation of a specific procedure such as: an emergency descent, a drop, an in-flight refueling, an engine failure, a jettison, referring to a jettison of fuel in the case of excess fuel for an emergency landing.

The second FMS 30 can also automatically adapt the parameters of the flight segments as a function of instructions by the crew and of the progress of the flight.

For example, in FIG. 3 second man-machine interfaces MCDU, KCCU, FMD 31 can be adapted in order to allow an insertion/modification/deletion of waypoints in the initial flight plan, an insertion/modification/deletion of parameters attached to an existing segment, insertion/modification/deletion of a procedure in the initial flight plan. The insertions/modifications/deletions are transmitted by the second man-machine interfaces 31 to the second FMS 30.

The second man-machine interfaces 31 moreover carry out the same functions as the first man-machine interfaces 100 shown in FIG. 1.

The second FMS 30, and notably a second FPLN function 33 of the second FMS 30, inserts/modifies/deletes the segments as well as their parameters. An insertion of a generic segment in the initial flight plan advantageously necessitates only a single generic segment formulation.

The second FMS 30, via the second FPLN 33, then transmits the segments as well as their parameters to display means, such as a second Flight Management System or FMD 32 or a second Navigational Display or ND 32, for display. Advantageously the single generic formulation of the segments makes it possible to provide a simplified man-machine interface, thus considerably reducing the in-flight workload of the crew and simplifying the training of the crew.

The second FMS 30 and notably the second FPLN 33, also transmits the points of the flight plan for display, notably to the second FMD 32 and to the second ND 32. The vertical flight segments can be displayed in the form of a list and/or on a graphic, thus giving the crew a synthetic view of the whole of the vertical flight. The list of points of each flight plan can be displayed in a reduced manner with the list of vertical flight segments, or in a complete form, according to the user's requirement. The display of the list of points of the flight plan can be carried out according to a vertical “fold/unfold” information method, “unfold” giving a complete list of the points of the flight plan and “fold” giving a reduced list of the points of the flight with the vertical segments.

The second FMS 30, via the second FPLN 33 also transmits the segments and their parameters to a second navigation data base, NAV DB 34, which saves them. The second data base NAV DB 34 also carries out the functions described for the first data base NAV DB 3 as shown in FIG. 1.

The second FPLN 33 then transmits the segments of the vertical flight plan 35 together with their parameters to a second function TRAJ 36. The second function TRAJ 36 carries out a calculation of the lateral flight path, or updates it if modifications have occurred in the list of segments. Then, the second function TRAJ 36 reinitializes the flight parameters associated with each segment of the list segments 35 as a function of the aircraft performance. The corrected flight parameters of the performance data are then transmitted to a second performance data base PERF DB 37 which saves them. The flight parameters can also be transmitted to the second FMD 32 for display.

The second performance data base 37 then saves the flight parameters and aircraft performance associated with each segment and transmits these parameters on request for example. The second performance data base 37 moreover carries out the same functions as the data base PERF DB 2 shown in FIG. 1.

The performance data relative to each segment can then be transmitted to a second prediction function 38. The second prediction function 38 notably calculates the speed and altitude flight profiles, as well as the times, the remaining fuel and the winds at the different points of the speed and altitude flight profiles. The speed and altitude flight profiles are then transmitted to a second guidance function 39. The speed and altitude flight profiles can also be transmitted to the second VD 32 for display.

The second guidance function 39 carries out a longitudinal distance sequencing of the segments. A sequencing the segments order can, for example, be transmitted to the FPLN 33, which then activates the current segment as a function of the segment sequenced by the aircraft. The active segment is therefore a vertical segment with respect to which the aircraft is considered to be flying at each moment of time. The second guidance function 39 calculates and transmits guidance instructions or orders relative to the active segment to the automatic pilot 90. The chaining of guidance instructions can be determined as a function of the active vertical flight segment, of the instructions given by the crew through the automatic pilot 190, of the planned and/or calculated parameters, and of the progress of the flight.

The automatic pilot 190 slaves the aircraft to the guidance orders. Thus, the parameters defined and/or calculated for each vertical flight segment, including for the transitions between segments, can be used for slaving the aircraft to a continuous vertical flight path and speed profile corresponding to a procedure or to a mission.

FIG. 4 is a diagrammatic representation of a first generic segment 40 according to the invention of the “Step From” type. The first segment 40 comprises a first point of the “Start Point” type 41 situated at a first altitude Alt1. The first segment comprises for example an altitude to reach instruction Alt2. The first segment 40 is therefore represented by a first step 43 starting from the first point in order to reach the altitude Alt2, for example with a slope and a speed selected by the pilot or depending on the type of segment. Then the first segment is composed of a second step 44 at constant altitude Alt2 comprising the acceleration or the deceleration and then the maintaining of a speed for example of the long distance cruise type, up to the end point of the first segment 42.

FIG. 5 is a diagrammatic representation of a second generic segment of the “Step To” type 45 according to the invention. The second segment 45 comprises a third step 46 of change of altitude starting from the first altitude Alt1 up to the second altitude Alt2 considered to have been reached exactly at a “Start Point” point 48. The change of altitude can be carried out according to a slope or a given thrust, and according to a defined vertical speed in order allow the change of altitude notably including the acceleration or the deceleration from the speed of the preceding segment. When the altitude change is accomplished, the second segment comprises a fifth step 47 starting from the third point “Start Point” 48 and ending at a fourth point “End Point” 49 at the defined speed. The altitude of the second segment 45 is constant between the third point “Start Point” 48 and the fourth point “End Point” 49. It includes the acceleration or deceleration and then the maintaining at a speed, for example of the long distance cruise type, along this level flight segment.

FIG. 6a shows a diagram of an example of an initial segment 60 of a flight plan (according to the prior art). The initial segment 60 comprises for example three waypoints referenced TAN, AGN, LMG. The flight altitude of the aircraft according to the initial segment is FL280, and the speed of the aircraft responds to the LONG RANGE speed instruction.

FIG. 6b shows a diagram of a possible modification according to the invention of the initial segment 60 shown in FIG. 6a. For example, a modification of the flight plan can relate to an avoidance of a vertical space between two points, for example TAN and LMG at the altitude FL300 and at the LONG RANGE speed. This vertical space to be avoided can be prohibited, restricted to certain uses at certain times, dangerous because of a degraded meteorological situation or penalizing because of winds, temperature or penalizing meteorological phenomena. The avoidance procedure consists for example of a change of level at maximum thrust of the OPEN CLIMB type at the MIN SPEED speed, followed by keeping to an altitude instruction in order to pass above the space to be avoided. Thus the avoidance procedure can be broken down into two generic segments: a third segment of the “Step To” type and a fourth segment of the “Step From” type. The third segment of the “Step To” type comprises a start point corresponding to the point TAN, an end point corresponding to the point LMG, an altitude instruction at FL300 and a speed instruction of the LONG RANGE type. The third segment CLB TO TAN also comprises a waypoint AGN. The climb of the aircraft in this third segment is of the “OPEN CLIMB” type and is carried out at the “MIN SPEED” speed in order to reach the instructed altitude at the point TAN. The fourth segment DES FROM LMG of the “Step From” type comprises a first entry point LMG, a speed instruction of the Long Range type and an altitude instruction at FL280. The descent of the aircraft in this fourth segment is carried out by a transition of the OPEN DES type at the Long Range speed.

FIG. 7a shows an example of a first set of segments according to the invention. The first set of segments according to the invention comprises a fifth segment of the “CLB TO” type, having as its end point the waypoint TOU, and as its instruction a procedure, for example, of avoiding an unstable air mass. In order to apply this procedure, the calculated start altitude is FL280 and the calculated start speed is LR, the altitude and speed instructions to reach are to climb to FL300 and then to stay there in level flight at the speed of 270 Kts until the end point GAI, the strategy for achieving this is to climb in OPEN CLIMB at a speed corresponding to a MIN TIME type of speed. A sixth segment of the “DES FROM” type has as its start point the end point of the fifth segment GAI and descends according to an OPEN DES type of descent at a speed LR. The instructed altitude to reach is FL270 and then the instructed speed to be held is LR. A seventh segment of the “CLB TO” type has as its end point the waypoint called AGN, at an instructed altitude of FL290 and with an instructed speed of 300 KT which represent a procedure of avoidance of an unstable air mass, with a transition to climb to AGN using a climb of the GEOMETRIC type at an instructed speed of 260 KT.

FIG. 7b shows the first set of segments after deletion of a segment between two segments of the first set of segments. The segment to be deleted is for example the sixth segment of the “DES FROM” type having GAI as its start point.

The principle applied for reconstructing a list of segments after deletion of one of the segments is to extend the parameters of the preceding segment until the end of the deleted segment. Thus, for example, when two segments (AAA-BBB) and (BBB-CCC) follow each other and the second segment (BBB-CCC) is deleted, the first segment (AAA-BBB) absorbs the second segment (BBB-CCC) in order to become a single segment (AAA-CCC) with propagation of the properties of the segment (AAA-BBB) over the whole of the single segment (AAA-CCC). Thus, a new fifth segment comprises a new waypoint: le point GAI. The altitude and speed instructions between the point TOU and GAI are the altitude and speed instructions of the original fifth segment, that is to say FL300 and 270 Kt. The seventh segment remains unchanged.

FIG. 7c shows the first set of segments after deletion of the fifth segment. In this case, the calculated start altitude is maintained up to the point GAI, the start point of the application of the instruction of the sixth segment. A new sixth segment of the “DES FROM” type, with a descent transition of the OPEN DES type at a Long Range speed, has as its start point the end point GAI of the deleted fifth segment, whilst retaining the instructions applicable to the sixth segment.

FIG. 8 shows an example of a segment according to the invention corresponding to a drop procedure, or DROP, the start point of which, START POINT, is the first point AP and the end point of which, END POINT, is the point EORP. In addition to the parameters of a generic segment such as described above, the segments corresponding to a drop procedure can comprise the following points:
AP, the acronym for Align Point, signifying the point of alignment;
DIP, the acronym for Drop Intercept Point, signifying the drop intercept point;
CARP, the acronym pour Computed Air Release Point, signifying the computed air drop point;
EODP, the acronym for End Of Drop Point, signifying the end of drop point;
EORP, the acronym for End Of Run Point, signifying the exit point.

The segments corresponding to a drop procedure can also comprise the following parameters:
A description of the drop zone, called Drop Zone:
   An identifier of the drop zone in a data base comprising a set of drop zones;
   Geographic coordinates of a reference point of the drop zone, called GIP, the acronym for Ground Impact Point signifying the point of impact on the ground;
   An altitude;
   An axis;
   A length;
   A front margin and a back margin respectively called Front Margin and Back Margin;
   A profile of wind and temperature above the drop zone;
A description of a drop procedure:
   An alignment distance, the distance between the points AP and CARP;
   A latest distance of capture of a drop altitude and speed: the distance between the points DIP and CARP;
   A distance of flight in a straight line necessary at the end of the drop in order to change to a following step of the procedure: the distance between the points EODP and EORP;
Parameters for each drop over the drop zone:
   A drop speed;
   An altitude or a height with respect to the drop ground;
   A delayed opening altitude in the case of parachute drops;
   A type of drop;
   A weight of the dropped load;
   A type and a number of parachutes;
   A position de the load in the hold;
   Lateral dX and longitudinal dY offsets between the points CARP and GIP, calculated so that the dropping of a load at the point CARP allows this load, subjected to the wind, to reach the intended GIP over the Drop Zone.

FIG. 9 shows an example of a segment according to the invention describing an in-flight refueling procedure, also called AAR, the acronym for the expression Air To Air Refueling currently denoting an in-flight refueling procedure, the starting point START POINT of which is the first point ARIP and the end point END POINT of which is the point ARCP. In addition to the parameters of a generic segment such as described above, a segment corresponding to an in-flight refueling procedure can comprise the following points and parameters:
ARIP, the acronym pour Air Refueling Initial Point, signifying the initial in-flight refueling point;
ARCP, the acronym pour Air Refueling Control Point, significant the in-flight refueling control point;
An approach flight path, called Inbound Course;
A turn direction, called Turn Direction.

In the same way, an SAR procedure, the acronym for the expression Search And Rescue, denoting a search and rescue procedure, can furthermore comprise the following parameters:
A type of geometry or pattern for an SAR zone, for example: ladder, expanded square, sector;
Geometric parameters of the pattern depending on its type:
   For a ladder: an axis, a width, a spacing of the rungs;
   For an expanded square: an initial axis, a direction of turns, a first segment length;
A Wind over the SAR zone;
A length of the SAR zone or a maximum number of segments or legs.

FIG. 10 shows an example of a segment according to the invention describing a fast descent procedure, or STEEP DESCENT according to the official English term. A fast descent procedure corresponds to a specialization of a segment of the “Step To” type in a descent. The fast descent procedure can be defined by a first portion 90 with a descent of the high speed IDLE type. The fast descent procedure can then be defined by a second portion 91 during which the aircraft is decelerating, also called level flight deceleration. Then the fast descent procedure can be defined by a segment 92 at constant slope to be defined and at a maximum speed corresponding to a final aircraft configuration on arrival at the point called 3D Fix.

Another procedure, called intermediate landing, can also be converted into a set of segments. In order to define an intermediate landing, a new point is defined. The new point notably comprises the parameters necessary for a defining a landing procedure at that point. If the landing at this new point is confirmed, the new point is converted into a runway. The second FMS 30 according to the invention automatically inserts a level flight for interception with a landing slope called Final Capture Altitude using a model of all the segments substantially equivalent to the one used for a drop procedure. In brief, an intermediate landing procedure can comprise two flight segments: a flight segment for descending and a flight segment for climbing again.

FIG. 11a shows two examples of a man-machine interface 70 allowing flight plan management according to the invention. For example, the man-machine interface 70 is presented in the form of a list comprising a set of time-sequenced segments of a flight plan. For the example in FIG. 11a, this interface shows a page called ACT FPLN SEGMENTS and a page called TMP FPLN SEGMENTS, each comprising a list of segments. In the example shown in FIG. 11a, each segment is always shown in the same order, that is to say a reference point or start point of the segment, an altitude to reach, a speed to reach and a type of segment. For the example shown in FIG. 11a, it is always specified that the change of altitude must start at the reference point, or that the change of altitude must end at the reference point. When the change of altitude must start at the reference point, according to the example shown in FIG. 11a, CLB FRM or DES FRM are indicated, these being acronyms signifying Climb From or Descent From reciprocally signifying “change of altitude whilst climbing from” and “whilst descending from”. When the change of altitude must end at the reference point, according to the example shown in FIG. 11a, CLB TO or DES TO is indicated, these acronyms signifying Climb To or Descent To, for the terms reciprocally signifying “change of altitude whilst climbing to”, “whilst descending to”. If there is no change of altitude, according to the example shown in FIG. 11a, only the indication LEVEL is displayed at the reference point, and the change of speed is mentioned with a new value to reach in the flight segment. Finally, the type of segment is displayed to indicate the nature of the segment that will have to be used; according to the example shown in FIG. 11a: the types CRZ, for initial cruise, STEP, for change of cruise level, DROP, for tactical drop procedure, LVL, for level cruise flight. Other examples of procedures can be displayed such as AAR, SAR, STEEP, DES for Descent.

FIG. 11b shows an example of a vertical flight plan according to the invention, such as described moreover in FIG. 11a. FIG. 11 comprises two examples of vertical flight profiles 80, 81. A first flight profile 80 is an altitude flight profile ALT as a function of the distance traveled DIST. A second profile is a speed flight profile SPD as a function of the distance traveled DIST.

A first point is a departure airport LFBO. A first segment is defined by a start point: LFBO, an altitude to reach FL120, a type of flight: CRZ for Cruise signifying cruise, a type of speed: LONG RNG. In FIG. 11b, the tenth segment is characterized by a climb phase, called CLIMB until one of the parameters defined for the segment is reached, at a point referenced T/C. The climb phase is followed by a phase at constant altitude FL120 and at constant speed of the LR type, once these latter two have been achieved.

A second point specified in FIG. 11 is called LLFE. A tenth segment is defined by taking the point LLFE as the start point for an eleventh segment with an instruction for a descent to an altitude of 3850 FT, with a speed of the LR type. The type of flight over this eleventh segment is CRZ for cruise.

A twelfth segment is a segment corresponding to a drop zone or DROP zone, defined by the points DIP, CARP, EODP, EORP. Over the drop zone, and notably over the point DIP, the instructed speed to reach is 144 Kt, the speed instruction is 4500 FT. The twelfth segment is a segment of the “STEP TO” type, with altitude ALT and speed SPD instructions.

A thirteenth segment is a segment of the “STEP FROM” type with an altitude instruction of FL160 and a speed instruction of MAX Endurance, signifying maximum endurance. The first point of the thirteenth segment is the point EORP, the last point of the drop zone of the twelfth segment.

A fourteenth segment is a segment of the “STEP TO” type with an altitude instruction of FL200 and a Max Endurance speed. The first point of the fourteenth segment is the point PYR14 at which the speed and altitude instructions are achieved.

A fifteenth segment is segment of the “STEP FROM” type. The first point of the fifteenth segment is the point named PYR13. The altitude instruction of the fifteenth segment is FL160 for a speed corresponding to Max Endurance.

A sixteenth segment is a segment of the “STEP FROM” type. The first point of the sixteenth segment is the point named STEFR. The altitude instruction is maintained at FL160 and the speed to be applied is 250 Kt.

A seventeenth segment is a segment of the “STEP FROM” type. The first point of the seventeenth segment is the point named MAXOU. The altitude instruction is maintained at FL160 and the speed instruction to apply is of the Long Range type.

An eighteenth segment corresponds to a phase of landing on an airport named LFPO. The eighteenth segment is therefore a segment of the “DESCENT” type allowing the aircraft to descend in level flight steps in order to land.

Advantageously, le method according to the invention makes it possible to sequence segments with different altitude and speed instructions as well as other characteristics or constraints in the same vertical flight plan in order that the vertical flight plan is compatible with the procedures applicable in the controlled air space and that it is compatible with the operational requirements both for civil operations and for special missions carried out by government aircraft for example.

The invention advantageously makes it possible to meet planning requirements using existing or future types of procedures. In fact, the concept used according to the invention is a concept that is advantageously flexible and able to evolve.

The method according to the invention makes it possible to break down into generic segments a flight plan constituted by several vertical segments having different altitudes, speeds and flying parameters. The generic segments according to the invention advantageously support all types of changes of level and of speed, including tactical missions. The generic segments according to the invention make it possible to specify an altitude and speed profile for the initial flight plan by individualizing each segment according to a type: level flight, climbing transition, descending transition, associated speed, or to the reference start point of the generic segment, and with changes of speed, altitude or distance. It makes it possible to make flight predictions in the context of this profile and to slave the aircraft to it in altitude and in speed.

The method according to the invention advantageously makes it possible to provide a summarized view of each flight plan constituted thereafter by a reduced list of segments.

The insertion of a procedure in the flight plan advantageously necessitates only one single generic formulation and therefore allows a simplified IHM (man-machine interface), resulting in a reduction of the in-flight workload and an improvement of the training time of the crew.

1. A method for managing a vertical flight plan of an aircraft comprising:
a first step of breaking down an initial flight plan into a succession of contiguous segments, each segment comprising a change of altitude and/or of speed;
a second step of calculating a lateral flight path of the flight plan based on the contiguous segments;
a third step of calculating a vertical profile and a speed profile based on the calculated lateral flight path;
a fourth step of determining an active segment during the flight of the aircraft, by longitudinal distance sequencing of the contiguous segments.

2. The method as claimed in claim 1 wherein each segment comprises:
at least one point of the initial flight plan;
a phase of transition between two consecutive segments providing continuity of the flight profiles with regard to altitude and speed between two consecutive segments.

3. The method as claimed in claim 1, further comprising a fifth step of generating guidance instructions on the basis of the active segment.

4. The method as claimed in claim 3, wherein the guidance instructions are displayed by a dedicated man-machine interface.

5. The method as claimed in claim 3, wherein the controls of the aircraft are slaved to the guidance instructions.

6. The method as claimed in claim 1, further comprising a step of modification of the contiguous segments, the contiguous segments being automatically updated in order to integrate the modification, the modification step being followed by steps of calculating a lateral flight path, of calculating a vertical profile and a speed profile.

7. The method as claimed in claim 1 wherein each flight plan is constituted by a sequence of generic segments.

8. The method as claimed in claim 7 wherein each flight plan is stored in a memory of the flight management system in the form of a sequence of generic segments.

9. The method as claimed in claim 7 wherein the list of points of each flight plan is able to be reduced for display with the list of the generic segments composed of the points of each flight plan.

10. A device for managing a vertical flight plan of an aircraft comprising a flight management system and man-machine interfaces, said flight management system:
breaks down an initial flight plan into a succession of contiguous segments, each segment comprising a change of altitude and/or of speed;
calculates a lateral flight path of the flight plan on the basis of the contiguous segments;
calculates a vertical profile and a speed profile on the basis of the calculated lateral flight path;
determines an active segment, during the flight of the aircraft, by a longitudinal distance sequencing of the contiguous segments.

11. The device as claimed in claim 10 wherein the flight management system breaks down the initial flight plan into segments comprising:
at least one point of the initial flight plan;
a phase of transition between two consecutive segments providing continuity of the flight profiles with regard to altitude and speed between two consecutive segments.

12. The device as claimed in claim 10, wherein the flight management system generates guidance instructions on the basis of the active segment.

13. The device as claimed in claim 12, wherein the man-machine interfaces display the guidance instructions.

14. The device as claimed in claim 12, wherein the flight management system transmits the guidance instructions to an automatic pilot of the aircraft.

15. The device as claimed in claim 10, wherein it modifies contiguous segments, the contiguous segments being automatically updated in order to integrate the modification, the modification of the contiguous segments being followed by calculation of a lateral flight path and calculation of a vertical profile and of a speed profile.

16. A device for managing a vertical flight plan of an aircraft comprising a flight management system and man-machine interfaces, said flight management system comprising:
a function FPLN breaking down an initial flight plan into a succession of contiguous segments, each segment comprising a change of altitude and/or of speed, at least one point of the of the initial flight plan, a phase of transition between two consecutive segments providing continuity of the flight profiles with regard to altitude and to speed between two consecutive segments, said FPLN function modifying the contiguous segments when there is a modification request coming from a man-machine interface;
a function TRAJ calculating a lateral flight path of the flight plan on the basis of the contiguous segments;
a prediction function calculating a vertical profile and a speed profile on the basis of the calculated lateral flight path;
a guidance function carrying out a longitudinal distance sequencing of the contiguous segments, said distance sequencing being transmitted to the function FPLN, the function FPLN determining an active segment, during the flight of the aircraft.

17. The device as claimed in claim 16, wherein the guidance function generates guidance instructions on the basis of the active segment, for sending to an automatic pilot of the aircraft.

18. The device as claimed in claim 17, wherein the man machine interfaces display, for each of the active, temporary or secondary flight plans:
the contiguous segments;
the active segment;
the principal parameters of the segment: a reference point or a point of departure, an altitude to be reached either exactly at the reference point, or by climbing or descending starting from the reference point, a speed or a flying parameter of the aircraft, a type of segment.
the guidance instructions;
and are adapted for entering modifications of the contiguous segments.
